(19) United States
(12) Patent Application Publication
(10) Pub. No.: US 2013/0000058 A1
(43) Pub. Date: Jan. 3, 2013

(54) MARINE GROWTH REMOVAL DEVICE

(76) Inventor: John Robert Archibald, Singapore (SG)

(21) Appl. No.: 13/574,494

(22) PCT Filed: Jan. 22, 2010
(86) PCT No.: PCT/SG2010/000018

§ 371 Date: Sep. 15, 2012

(51) Int. Cl. B08B 1/04

(52) U.S. Cl. 15/21.1

(57) ABSTRACT

According to embodiments of the invention, there is provided a marine growth removal device, adapted to be mounted to a drive motor which allows the marine growth removal device to be rotatable about an axis, the marine growth removal device including: a base structure having a top surface; and a plurality of rigid stripping elements rotatably mounted to the base structure, wherein a stripping portion of the plurality of rigid stripping elements passes through the base structure to extend from the top surface of the base structure.

### FIELD OF THE INVENTION

The invention relates to a marine growth removal device.

### BACKGROUND OF THE INVENTION

Hydraulic wire brushes have been tried in the past for marine growth cleaning but have never proved to be capable of removing anything more than soft growth and sponges or a very light coating of hard marine growth. This handicap is due entirely to the lack of a suitable brush head—even the most robust industrial-sized brush is reduced to a clogged and twisted useless wreck after a few minutes of contact with a well-established colony of limpets, barnacles, clams and tubeworms.

WO 99/48623 discloses a cleaning device for cleaning the outer skin of aircraft, the bodies of land vehicles, or the hulls of boats. The cleaning device has a cleaning head which is arranged on the free end of a longitudinally extended, tubular shaft and comprises a cleaning tool. The cleaning tool is driven in a rotating manner by means of an electric motor.

Presently, two methods are commonly used for the subsea removal of heavy, hard marine growth (HHMG): hand tools and high pressure (HP) water blasting from for example, the underside of a ship's hull.

Hand tools such as scrapers and chipping hammers are extremely diver intensive and time consuming. As such, their use in water is restricted either to cleaning very small areas or when other cleaning methods are not available.

HP water blasting is presently considered a cost-effective method of removing HHMG underwater and has been used extensively in the commercial diving industry for over 20 years. It can remove most types of marine growth without damaging the underlying paint coat and is about ten times faster than using hand tools. However, HP water blasting has considerable limitations in certain underwater situations as the equipment requires a certain degree of both skill and experience to be used efficiently. To use the blaster safely, a diver requires both hands while remaining stable underwater.

Although an effective tool for cleaning a few square metres, HP water blasting is not efficient if the job involves cleaning areas of tens of square metres or having to constantly move location. From the diver's perspective, the underside of a ship's hull is a large, flat and featureless plain, devoid of a structure to which to tie a rope or wire.

Owing to the complete lack of purchase points needed to attach the rigging necessary to get the blaster and hose to the worksite and provide the diver-operator with some form of stability, HP water blasting soon proves to be an expensive and time-consuming operation.

There is thus a need to improve the effectiveness of marine growth cleaning/removal, especially in cleaning the underside of any vessel greater than 20 metres LOA (length overall).

### SUMMARY OF THE INVENTION

According to embodiments of the invention, there is provided a marine growth removal device, adapted to be mounted to a drive motor which allows the marine growth removal device to be rotatable about an axis, the marine growth removal device including: a base structure having a top surface; and a plurality of rigid stripping elements rotatably mounted to the base structure, wherein a stripping portion of the plurality of rigid stripping elements passes through the base structure to extend from the top surface of the base structure.

The invention will be further illustrated in the following description, with reference to the drawings.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A is a perspective view of a marine growth removal brush according to one embodiment of the present invention.

FIG. 1B is a partial perspective view of a marine growth removal brush according to another embodiment of the present invention.

FIG. 2 shows a biasing element being aligned with and coupled to a respective stripping element.

FIG. 3 shows a cross-sectional view of a portion of a marine growth removal device according to another embodiment of the present invention.

FIG. 4A shows a cross-sectional view of a portion of a marine growth removal device according to another embodiment of the present invention.

FIG. 4B shows a plan view of a marine growth removal device according to one embodiment of the present invention.

FIG. 4C shows a tip of a stripping element, according to an embodiment of the present invention, tracing a circle as the stripping element rotates.

FIGS. 5 to 8 show embodiments of a stripping element for use with a marine growth removal device according to one embodiment of the present invention.

FIGS. 9A to 9C show further embodiments of a stripping element for use with a marine growth removal device according to one embodiment of the present invention.

FIG. 10 is a perspective view of two coupled marine growth removal devices, according to an embodiment of the present invention.

FIGS. 11A to 11D are perspective views of individual components of the marine growth removal device of FIG. 1.

FIGS. 12A and 12B show different cross-sectional views of portions of a marine growth removal device according to another embodiment of the present invention.

FIGS. 13A and 13B are close-up views of the marine growth removal device of FIG. 1B.

FIG. 14 shows a rigid stripping element being depressed into a base structure when the rigid stripping element encounters a protrusion.

FIG. 15 shows a marine growth removal device, according to one embodiment of the present invention, being applied onto a planar surface.

### DETAILED DESCRIPTION

According to one embodiment of the present invention, a marine growth removal device is provided. The marine growth device is adapted to be mounted to a drive motor which allows the marine growth removal device to be rotatable about an axis. The marine growth removal device includes a base structure having a top surface. A plurality of rigid stripping elements is rotatably mounted to the base structure. A stripping portion of the plurality of rigid stripping elements passes through the base structure to extend from the top surface of the base structure.

The rotatably mounted rigid stripping elements facilitate removal of marine growth. Thus, only some of the plurality of rigid stripping elements may be rotatably mounted to the base structure. On the other hand, all of the plurality of rigid stripping elements may be rotatably mounted to the base structure.

At least one of the plurality of the rigid stripping elements may be able to translate through the base structure to vary the height to which the at least one of the rigid stripping elements extends from the top surface of the base structure. In another embodiment, all the rigid stripping elements are able to translate through the base structure to vary the height to which they extend from the top surface of the base structure.

A biasing element may be used to engage each respective rigid stripping element to have each rigid stripping element biased to extend from the top surface of the base structure. On the other hand, one of the plurality of the biasing elements may be used to bias more than one of the rigid stripping elements. Rather than being a separate element, in another embodiment, the biasing element may be an integral portion of each of the plurality of stripping elements.

A mounting plate may be coupled to a bottom surface of the base structure, the bottom surface being opposite to the top surface of the base structure. In one embodiment, the biasing element may be disposed between the mounting plate and the base structure. Alternatively, in another embodiment, the biasing element may be disposed within the mounting plate.

Any device that can perform biasing may be used for the biasing element. For instance, the biasing element may be a spring or a deformable material. The biasing element may also be an actuator coupled to a hydraulic system.

The stripping portion of the plurality of the rigid stripping elements may have any suitable structure that facilitates the stripping of marine growth. Examples of such suitable structures include: an “L” shaped bend; an arc shaped bend; a curved shaped bend; a single or multiple pointed end; a nut and a cylindrical protrusion.

At least one of the plurality of the rigid stripping elements may have a restraining element. The restraining element prevents the plurality of the rigid stripping elements from translating beyond a certain height from the top surface of the base structure by engaging a bottom surface of the base structure, the bottom surface opposite to the top surface of the base structure. Such restraining elements include a washer or a protrusion. All of the plurality of rigid stripping elements may be provided with a respective restraining washer. In one embodiment the restraining washer may be integral with each of the rigid stripping elements. In another embodiment, the restraining washer may be separately secured to each of the rigid stripping elements.

The plurality of the rigid stripping elements may have any kind of arrangement pattern with respect to the base structure. For instance, the rigid stripping elements may be arranged in symmetrically spaced groups. The rigid stripping elements may alternatively also be asymmetrical arranged on the base structure.

The base structure may have an individual opening for each of the plurality of the rigid stripping elements. The base structure may have a first plate; a second plate and a spacer to distance the first plate from the second plate. In other embodiments, the base structure may be a single plate, rather than a combination of plates. The base structure may also be realised using any number of plates, with a respective spacer separating each pair of the any number of plates.

The mounting plate may be provided with a motor shaft receptacle for mounting to a drive motor. The motor shaft receptacle may be located on any portion of the mounting plate as long as the marine growth removal device is rotatable about an axis, through powering a drive motor connected to the motor shaft receptacle. The motor shaft receptacle may be provided on a surface opposite to the surface the mounting plate is coupled to the base structure. The motor shaft receptacle may be formed on the mounting plate or may be attached to the mounting plate.

The plurality of rigid stripping elements may be any material that is suitable to remove the marine growth, for example a metal or an alloy thereof. Examples of suitable metals include iron, titanium and aluminium. Examples of suitable alloys include stainless steel, cemented carbide (cerment), cast iron and Ni-hard.

The base structure may further include at least one protrusion formed along a perimeter of the base structure. The at least one protrusion may be planar with the base structure and the at least one protrusion shaped to correspond to a notch formed along the perimeter of the base structure. The base structure may be formed of shapes having an axis of symmetry. Such shapes include a disc or an ellipse.

While embodiments of the invention will be shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

It will be appreciated that common numerals, used in the relevant drawings, refer to components that serve a similar or the same purpose.

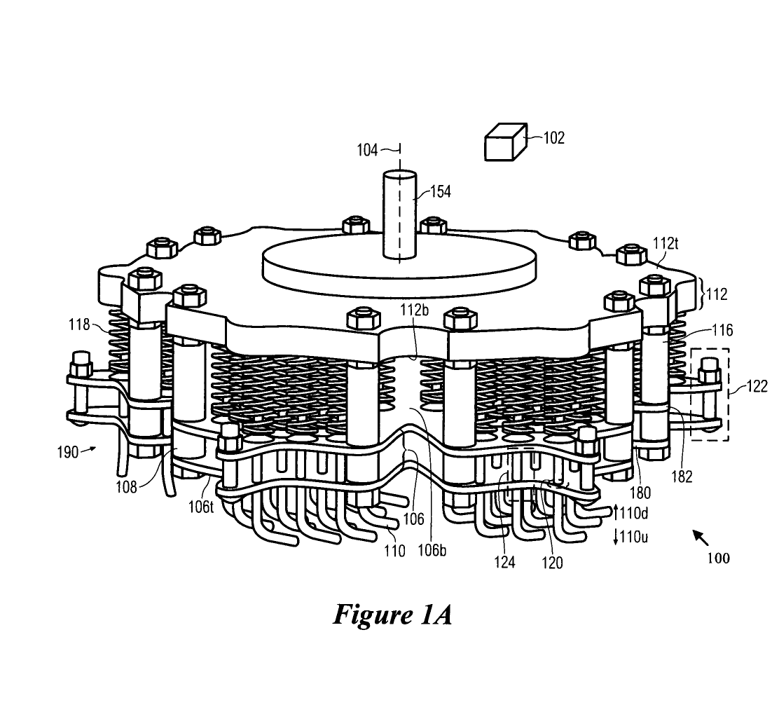

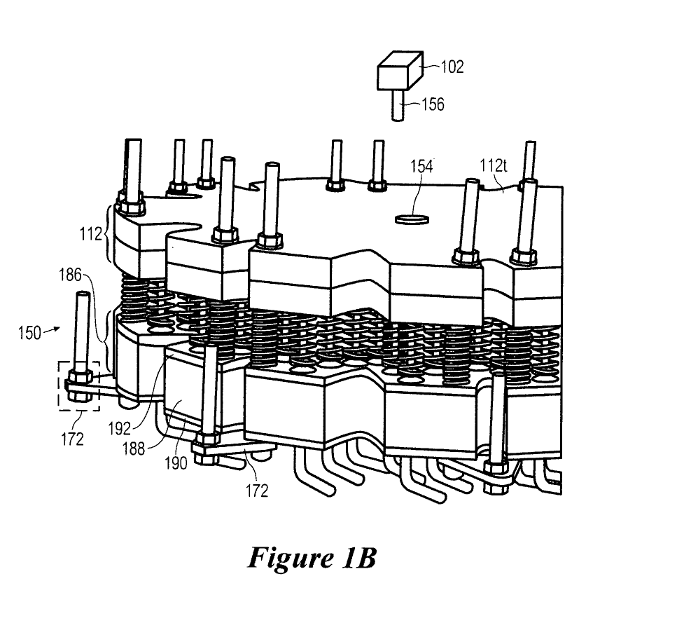

FIG. 1A is a perspective view of a marine growth removal device 100 according to one embodiment of the present invention.

The marine growth removal device 100 is adapted to be mounted to a drive motor 102 so that the marine growth removal device 100 is rotatable about an axis 104.

The marine growth removal device 100 includes a base structure 106 having a top surface 106t. The base structure 106 has a bottom surface 106b opposite to the top surface 106t. A spacer 108 separates the bottom surface 106b from the top surface 106t. The base structure 106 can be of any suitable rigidity and has for example a thickness of around 15 mm.

In the embodiment shown in FIG. 1A, the base structure 106 includes a first plate 180 and a second plate 182. The spacer 108 separates the first plate 180 a distance from the second plate 182. Implementing the base structure 106 as two plates 180 and 182 of thickness of e.g. around 2 to 3 mm each, instead of a single plate of thickness of e.g. around 15 mm, may provide for a lighter marine growth removal device 100 and may also save manufacturing costs. In addition, the first plate 180 engages a first portion of each of the plurality of the rigid stripping elements 110 at where the rigid stripping element 110 passes through the first plate 180. Similarly, the second plate 182 engages a second portion of each of the plurality of the rigid stripping elements 110 at where the rigid stripping element 110 passes through the second plate 182. The engagement, at two spaced apart portions, reduces wobbling at where each of the plurality of the rigid stripping elements 110 is mounted to the base structure 106.

The base structure may also be realised (not shown) using any number of plates, with a respective spacer separating each pair of the any number of plates. It has been observed that in operating an embodiment of the invention where the marine growth removal device uses a base structure with more plates, the degree of suction to remove marine growth is improved, especially when the embodiment of the invention is used against a planar surface.

A plurality of rigid stripping elements 110 is rotatably mounted to the base structure 106. A stripping portion of the plurality of rigid stripping elements 110 passes through the base structure 106 to extend from the top surface 106t of the base structure 106. In this manner, each of the plurality of the rigid stripping elements 110 is able to rotate about an opening 120 (formed in the base structure 106) through which the respective stripping portion passes through.

In addition to rotational movement, at least one of the plurality of the rigid stripping elements 110 of the embodiment of the marine growth removal device 100 may be adapted to translate through the base structure 106 to vary the height to which the at least one of the rigid stripping elements 110 extends from the top surface 106t of the base structure 106. In the embodiment shown in FIG. 1A, the at least one of the rigid stripping elements 110 is able to move vertically upwards 110u and downwards 110d with respect to the base structure 106. It will be appreciated that, in other embodiments, each of the plurality of rigid stripping elements 110 may be translatable along an inclined axis through the base structure 106, so that each of the plurality of rigid stripping elements 110 is movable in a direction 110u away from and in a direction 110d towards the top surface 106t of the base structure 106.

Each of the rigid stripping elements 110 is made of material and thickness suitable for removal of marine growth. As such, the rigid stripping elements 110 retain their shape and structure during operation of the marine growth removal device 100, i.e. even after the rigid stripping elements 110 come into contact with marine growth that is to be removed.

The plurality of rigid stripping elements 110 may have a straight portion, wherein the bent portion connects to the straight portion. The straight portion protrudes perpendicular from the top surface 106t of the base structure 106, wherein the bent portion forms an angle relative to the straight portion. The bent portion is located distal from where the straight portion protrudes from the top surface 106t of the base structure 106. It will be appreciated that the bent portion reduces damage applied to paintwork on a surface the rigid stripping element 110 is applied thereto.

During operation, the marine growth removal device 100 is rotated by the drive motor 102. The top surface 106t of the base structure 106 is brought into proximity with marine growth. Without being bound by theory, it is believed that the stripping portion of the plurality of the rigid stripping elements 110 chips off the marine growth via impact. Chipping occurs in a layered manner, i.e. an uppermost layer of the marine growth is first removed, followed by removal of an underlining layer.

Thus, during operation of the marine growth removal device 100, the rigid stripping elements 110 provide a working zone capable of cutting or abrading a surface upon which the marine growth removal device 100 is applied. Such applied surfaces include flat-plates, large tubular surfaces and the underside of a ship's hull. As the marine growth removal device 100 comes into contact with marine growth on an application surface, the impact of the rotating rigid stripping elements 110 against the marine growth will strip the marine growth from the application surface. The embodiment of the marine growth removal device 100 may be able to remove heavy, hard marine growth (HHMG) of any suitable thickness, for example up to 300 mm thick, cleaning down to the paint coat or a shell base of, for example, less than 5 mm thick. When connected to a suitable drive motor 102, the marine growth removal device 100 is able to clean a typical seam weld inspection (150 mm×75 m) in under an hour. These represent significant improvement in work rate over hand tools or water blasting.

Compared with water blasting, the marine growth removal device 100 has no risk of accidental ‘gunshot’ wounding that may incur from water blasting. ‘Gunshot’ wounding involves expensive medical treatment for the affected diver, paid medical leave and in the worst case, permanent disability. This means, from a health point of view, less risk for the diver and, from an economic perspective, less expensive insurance cover for a diver using the marine growth removal device 100.

Further, the drive motor 102 is typically powered through a hydraulic hose. Hydraulic hoses by their very nature (oil filled) are almost weightless when in water, allowing a diver a great deal of manoeuvrability and freedom. This greatly reduces diver fatigue as well as increases his work rate. The marine growth removal device 100 can be quickly deployed with little or no rigging and can be moved to different areas of the worksite in a matter of minutes. A single-length hydraulic hose eliminates any leaks from damaged coupling joints. When no longer required, the marine growth removal device 100 can be easily recovered to the surface by one man.

The marine growth removal device 100 and its required peripheral components are compact and lightweight and can be moved by a small van or pickup truck, avoiding the hire of lorries, cranes or forklifts when transporting, loading or unloading. The hydraulic power pack required to operate the marine growth removal device 100 is about the size of a large suitcase and can be lifted and moved by two men. This allows marine growth removal operations to be conducted from much smaller boats or confined work areas. On the other hand, a typical water blaster unit is the size of a small van and weighs 2-3 tonnes while each 10-metre section of the HP hose weighs 50 kg.

Each of the plurality of rigid stripping elements 110 is provided with a biasing element 118. The biasing element 118 is able to engage with a respective rigid stripping element 110 to have each rigid stripping element 110 biased to extend from the top surface of the base structure. Each biasing element 118 provides the force necessary for the respectively engaged rigid stripping element 110 to be biased to protrude from the top surface 106t of the base structure 106.

The marine growth removal device 100 further includes a mounting plate 112 coupled to the bottom surface 106b of the base structure 106. A bottom surface 112b of the mounting plate 112 faces the bottom surface 106b of the base structure 106. The mounting plate 112 has a top surface 112t that is opposite to its bottom surface 112b. The mounting plate 112 has a thickness of around 11 mm.

The mounting plate 112 is provided with a motor shaft receptacle 154 for mounting to the drive motor 102. The motor shaft receptacle 154 is provided on the top surface 112t (i.e. a surface of the mounting plate 112 opposite to the surface where the mounting plate 112 is coupled to the base structure 106) of the mounting plate 112.

The mounting plate 112 is secured to the base structure 106 through several support members 116. The support members 116 distance the base structure 106 from the mounting plate 112.

FIG. 1A shows the mounting plate 112 to be a single plate. However, in other embodiments of the invention, the mounting plate may be realised (not shown) using any number of plates, with a respective spacer separating each pair of the any number of plates.

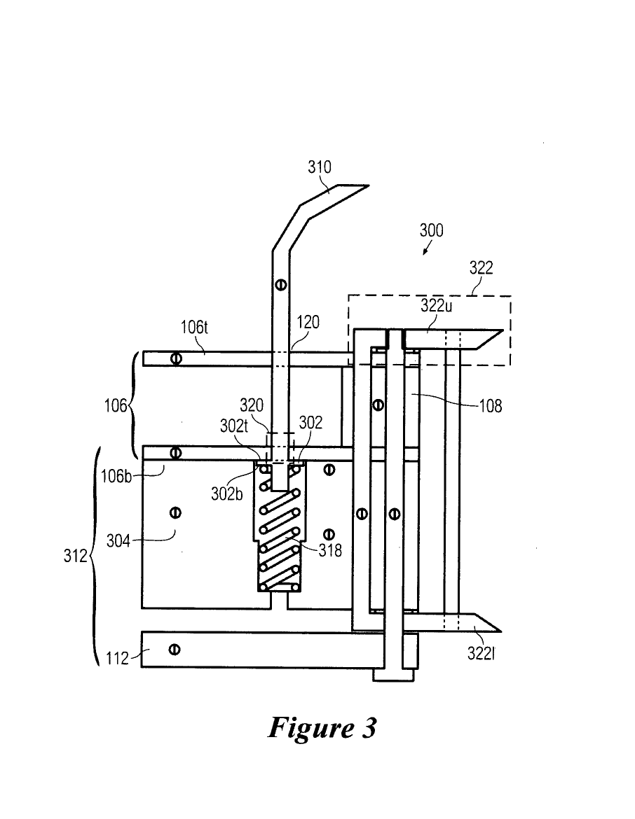

In the embodiment shown in FIG. 1A, the biasing element 118 is disposed between the mounting plate 112 and the base structure 106. In another embodiment (see FIG. 3), the biasing element 318 is disposed within the mounting plate 312. The biasing element (118, 318) may be a spring made of material such as steel or copper or implemented as a rigid actuating element coupled to a hydraulic system. The biasing element (118, 318) may also be a deformable material such as compressible rubber.

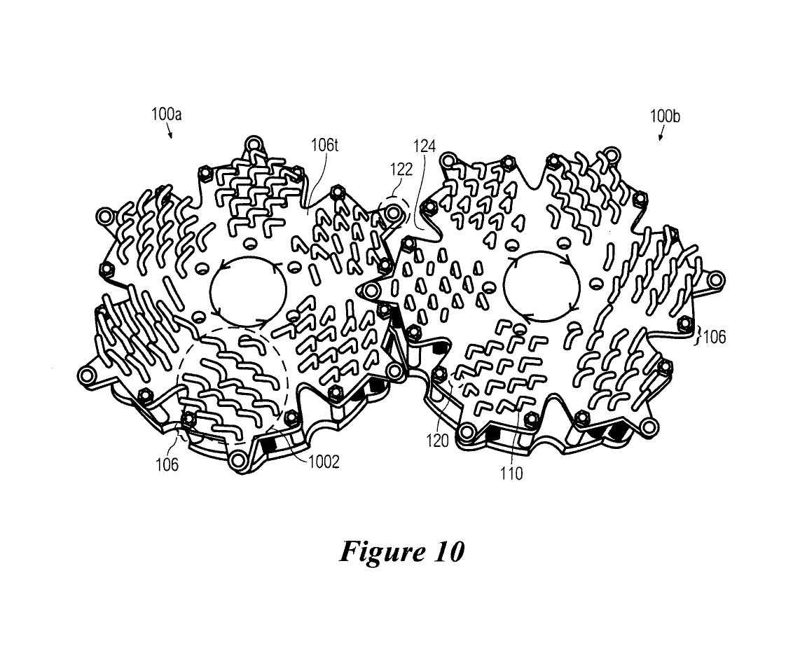

At least one protrusion 122 is formed along a perimeter of the base structure 106. The at least one protrusion 122 is planar with the base structure 106 and shaped to correspond to a notch 124 formed along the perimeter of the base structure 106. The notch 124 is designed to accommodate the protrusion 122 of an adjacent marine growth removal device (see FIG. 10) when two marine growth removal devices are used together.

FIG. 1B is a partial perspective view of a marine growth removal device 150 according to another embodiment of the present invention.

A difference between the marine growth removal device 150 of FIG. 1B and that of FIG. 1A is that the base structure 186 has a solid material block 188 sandwiched between a first plate 190 and a second plate 192. For the marine growth removal device 100 of FIG. 1A, the base structure 106 uses spacers 108 instead of a solid material block 188. Similar to the marine growth removal device 100 of FIG. 1A, the marine growth removal device 150 is provided with a motor shaft receptacle 154 for mounting to a drive motor 102. The motor shaft receptacle 154 is provided on the top surface 112t of the mounting plate 112.

Another difference between the marine growth removal device 150 of FIG. 1B and that of FIG. 1A is that the protrusion 172 along a perimeter of the base structure 106 is secured onto a top surface of the base structure 186. On the other hand, for the marine growth removal device 100 of FIG. 1A, the protrusion 122 is integral with the base structure 106.

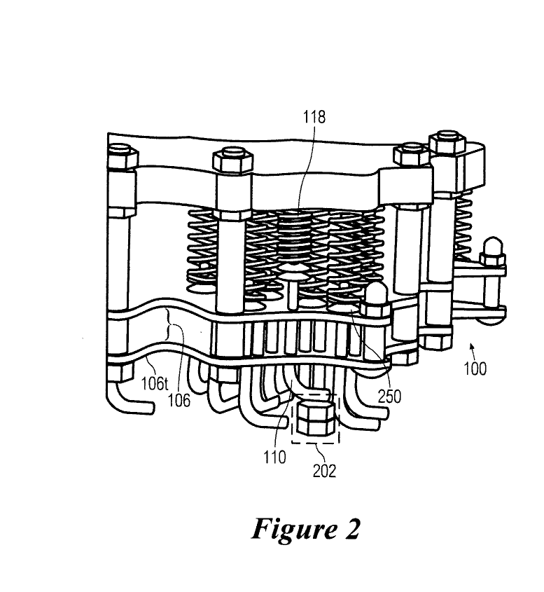

FIG. 2 shows a portion of the marine growth removal device 100, as viewed from one side (illustrated using arrow 190 in FIG. 1A) of the marine growth removal device 100.

FIG. 2 shows that each biasing element 118 is aligned with and coupled to a restraining washer 250 of a respective rigid stripping element 110. FIG. 2 also shows that when a rigid stripping element 110 encounters a protrusion 202 (such as a rivet or weld) on a surface upon which the marine growth removal device 100 is applied, the rigid stripping element 110 will move towards the base structure 106 and thereby compress a respective biasing element 118 coupled to the rigid stripping element 110. From FIG. 2, it can thus be appreciated that the biasing element 218, along with the plurality of rigid stripping elements 110 being movable relative to the base structure 106, reduces damage caused to protrusions that are part of the structure to which the marine growth removal device 100 is applied.

The plurality of rigid stripping elements 110 has a straight portion, and a bent portion. The straight portion protrudes perpendicular from the top surface 106t of the base structure 106, while the bent portion is substantially perpendicular to the straight portion. The bent portion is located distal from where the straight portion protrudes from the top surface 106t of the base structure 106.

FIG. 3 shows a cross-sectional view 300 of a portion of a marine growth removal device 300 according to another embodiment of the present invention.

FIG. 3 shows a rigid stripping element 310 protruding through an opening 120 on the top surface 106t of the base structure 106 and protruding through an opening 320 of a bottom surface 306b of a mounting plate 312. Compared to the mounting plate 112 of the marine growth removal device 100 (see FIG. 1A), a spring chamber block 304 is provided inside the mounting plate 312 of the marine growth removal device 300. The spring chamber block 304 allows a biasing element 318 to be disposed within the mounting plate 312.

Another difference between the marine growth removal device 300 and the marine growth removal device 100 of FIG. 1A is the manner in which the protrusion (compare reference numeral 122 in FIG. 1A) is realised in the marine growth removal device 300. The protrusion 322 for the marine growth removal device 300 is formed using an integral piece having a drive plate 322u located on the top surface 106t of the base structure 106 and a drive plate 3221 located beneath the spring chamber block 304.

The rigid stripping element 310 has a retaining washer 302. One side 302t of the retaining washer 302 rests against the bottom surface 106b of the base structure 106 when the rigid stripping element 310 is fully biased (as shown in FIG. 3) by the biasing element 318. Another side 302b (opposite to side 302t) of the retaining washer 302 is in contact with the biasing element 318. The retaining washer 302t serves the purposes of providing an ample contact area for the biasing element 318 and prevents the rigid stripping element 310 from being ejected from the base structure 106.

It will be appreciated that the rigid stripping element 310, shown in FIG. 3, is different from the rigid stripping element 110 of the marine growth removal device 100 of FIG. 1A. For FIG. 1A, the rigid stripping element 110 is only bent at one location. In FIG. 3, the rigid stripping element 310 is bent at two locations.

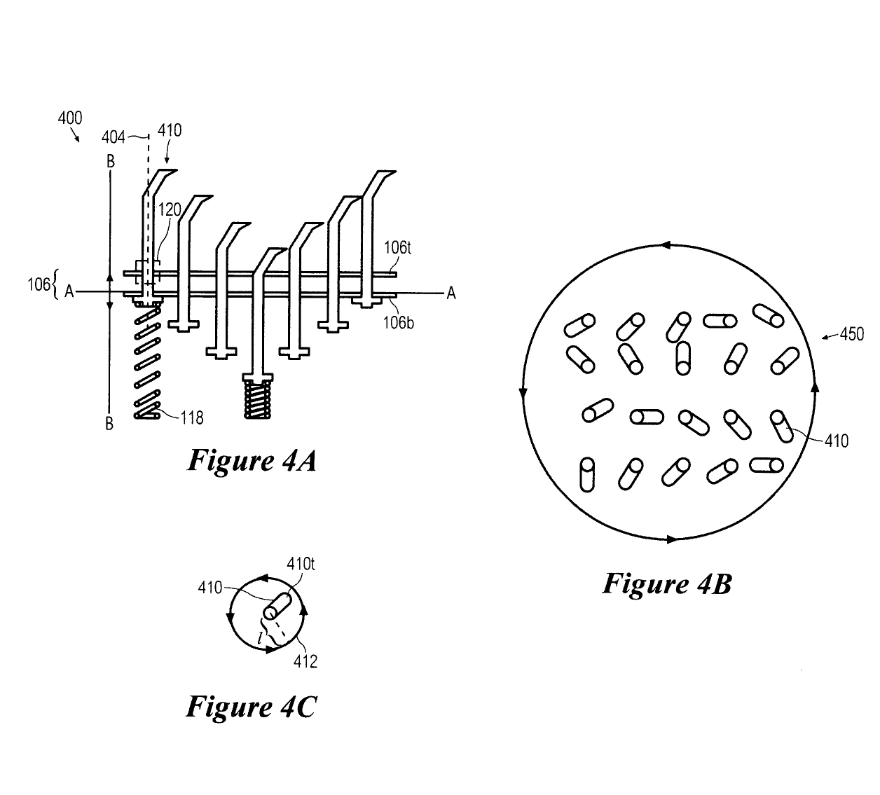

FIG. 4A shows a cross-sectional view 400 of a portion of a marine growth removal device according to another embodiment of the present invention.

In FIG. 4A, each stripping element 410 is individually coupled to a respective basing element 118. However, several of the biasing elements 118 are omitted in FIG. 4A for the sake of simplicity and clarity. Comparing with FIG. 3, it can be seen that there is no spring chamber block for the marine growth removal device of FIG. 4.

The cross-sectional view 400 illustrates that the stripping element 410 is able to move vertically up and down along an axis B-B (i.e. movable in a direction away in a direction towards the top surface 106t of the base structure 106). The stripping element 410 is also able to rotate about a vertical axis 404 that runs perpendicular to the opening 120 (and also parallel to axis B-B), the vertical axis 404 being located at the centre of the opening 120.

FIG. 4B shows a plan view 450 of the marine growth removal device. In FIG. 4B, each of the rigid stripping elements 410 is rotated to different extents.

FIG. 4C shows that as the stripping element 410 rotates, the tip 410t traces a circle 412 having a radius of length l. The length l is determined by the length of the tip 410t, where the length l is typically around, for example, 16 mm.

Each of the plurality of the rigid stripping elements 410 is individually coupled to and protrudes from an opening 120 provided in the base structure 106. There is an interval of around, for example, 15 mm between adjacent openings 120.

In this manner, each of the plurality of the rigid stripping elements 410 is individually connected to the base structure 106 and spaced apart from another of the plurality of the rigid stripping elements 410.

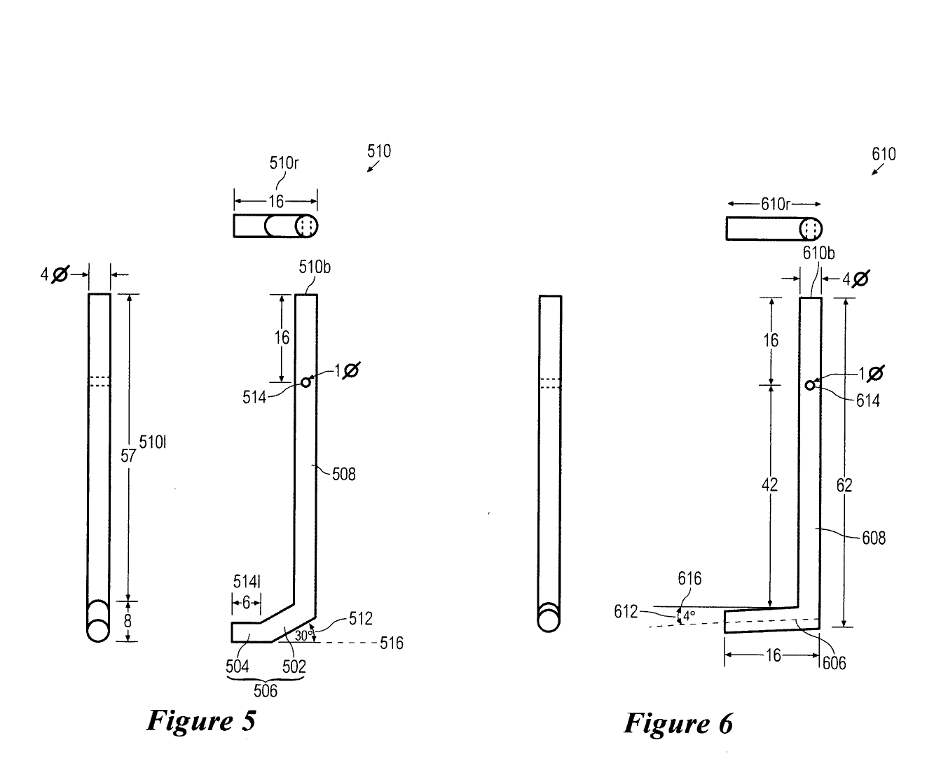

The stripping portion of the plurality of the rigid stripping elements 410 includes any one or more of the following structures: an “L” shaped bend; a single or multiple pointed end; a nut and a cylindrical protrusion. These various embodiments of the stripping portions are shown with reference to FIGS. 5 to 8 and 9A to 9C. It will be appreciated that a marine growth removal device, according to any embodiment of the present invention, may use any one or more of the rigid stripping elements shown in FIGS. 5 to 8 and 9A to 9C.

FIGS. 5 to 8 and 9A to 9C show additional embodiments of rigid stripping elements (510, 610, 710, 810, 910, 960 and 980) for use with a marine growth removal device of the present invention. A plan view and two different side views of each of the stripping element (510, 610, 710, 810, 910, 960 and 980) are shown in FIGS. 5 to 8 and 9A to 9C.

In FIG. 5, the rigid stripping element 510 has a straight portion 508 and a bent portion 506. The bent portion 506 is “L” shaped, having an end portion 504 and a middle portion 502. The middle portion 502 adjoins the end portion 504 to the straight portion 508. The middle portion 502 forms an acute angle 512 of around, for example, 30° to an axis 516 that is perpendicular to the straight portion 508. The end portion 504 has a length 5041 of around, for example, 6 mm and is aligned with the axis 516, i.e. the end portion 504 is also perpendicular to the straight portion 508.

In FIG. 6, the rigid stripping element 610 has a straight portion 608 and a bent portion 606. The bent portion 606 is “L” shaped and forms an acute angle 612 of around, for example, 4° to an axis 616 that is perpendicular to the straight portion 608.

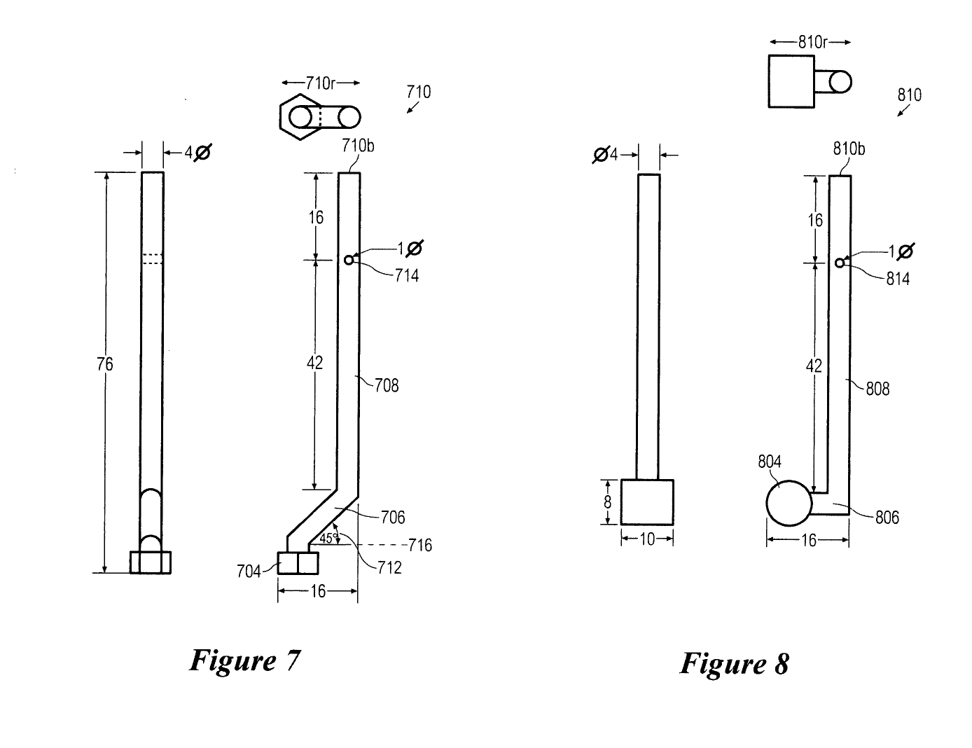

In FIG. 7, the rigid stripping element 710 has a nut 704. The stripping element 710 has a straight portion 708 and a bent portion 706. The nut 704 is formed at an end of the bent portion 706. The bent portion 706 adjoins the nut 704 to the straight portion 708. The bent portion 706 forms an acute angle 712 of around, for example, 45° to an axis 716 that is perpendicular to the straight portion 708. The nut 704 is aligned with the straight portion 708.

In FIG. 8, the rigid stripping element 810 has a cylindrical protrusion 804. The stripping element 810 has a straight portion 808 and a bent portion 806. The cylindrical shaped element 804 is formed at an end of the bent portion 806. The bent portion 806 adjoins the cylindrical shaped element 804 to the straight portion 808. The bent portion 806 is perpendicular to the straight portion 808, so as to form an “L” shaped bend.

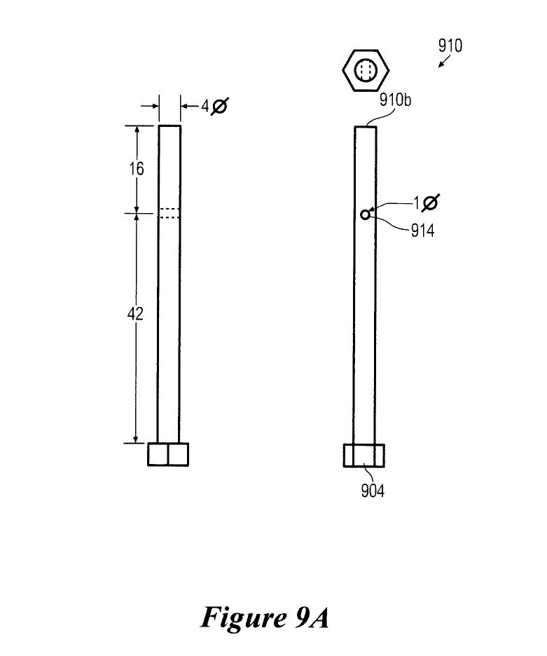

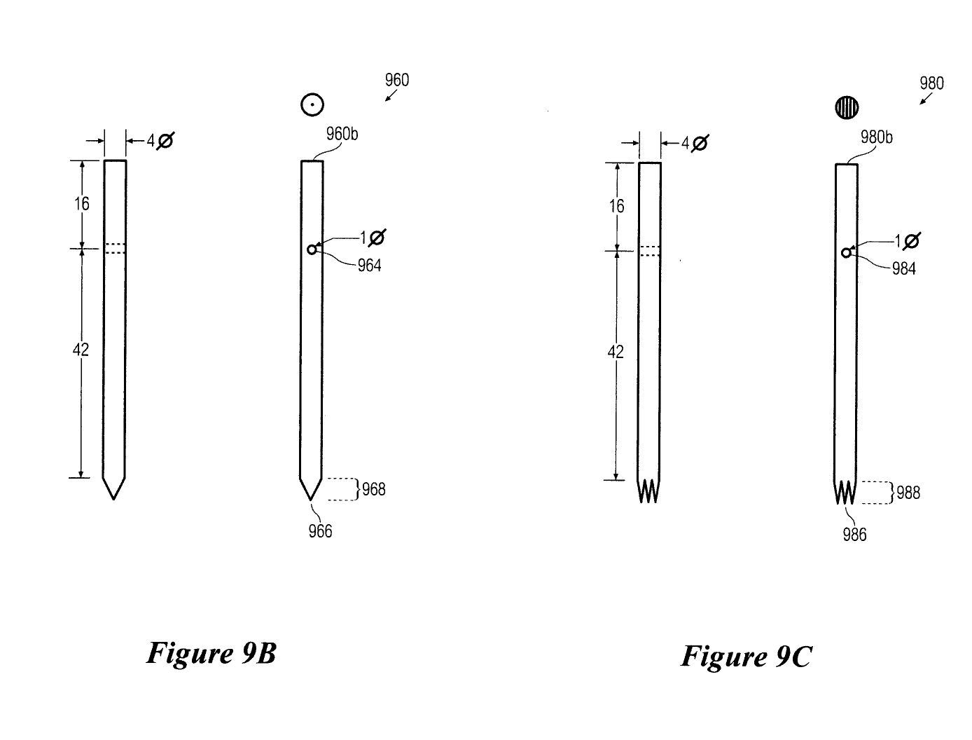

In FIG. 9A, the rigid stripping element 910 has a nut 904. In contrast to the other rigid stripping elements 510, 610, 710 and 810, the rigid stripping element 910 is straight and does not have a bent portion.

The rigid stripping elements 960 and 980 of FIGS. 9B and 9C also are straight and do not have a bent portion. At a respective end, each of the rigid stripping elements 960 and 980 has a single pointed end 966 and a multiple pointed end 986. The pointed end 966 and the multiple pointed end 986 tapers over a distance 968 and 988 of around, but not restricted to, 5 mm respectively. Although FIG. 9C shows that there are three pointed ends, the rigid stripping element 980 may have any number of pointed ends.

For FIGS. 5 to 8, the straight portions (508, 608, 708 and 808) of the rigid stripping elements (510, 610, 710 and 810) each have a length of around, for example, 57 mm. Further, while the bent portions 506, 606 and 806 (see FIGS. 5, 6 and 8) form “L” shaped bends with their respective straight portions 508, 608 and 808, other bend shapes such as an arc bend (not shown) or a curved bend (not shown) may be used. In use, the rigid stripping elements (510, 610, 710 and 810) may rotate, about their respective coupling points on the top surface of a base structure of a marine growth removal device, to define circles having a radius (510r, 610r, 710r and 810r) of around, for example, 16 mm.

For FIGS. 5 to 8 and 9A to 9C, openings (514, 614, 714, 814, 914, 964 and 984) are machined into the rigid stripping elements (510, 610, 710, 810, 910, 960 and 980) at a distance of about 16 mm from their respective bases (510b, 610b, 710b, 810b, 910b, 960b and 980b) of the rigid stripping elements (510, 610, 710, 810, 910, 960 and 980). The openings (514, 614, 714, 814, 914, 964 and 984) each have a diameter of around 1 mm, which is also indicated by the symbol “10”. The openings (514, 614, 714, 814, 914, 964 and 984) are each meant to accommodate a retaining washer, similar to the retaining washer 302 shown in FIG. 3. The restraining washer is capable of engaging a bottom surface of a base structure of a marine growth removal device, the bottom surface opposite to the top surface of a base structure (see FIG. 1A), although it will be appreciated that the retaining washer is not shown in FIGS. 5 to 9B for the purposes of clarity. Further, each of the bases (510b, 610b, 710b, 810b, 910b, 960b and 980b) of the rigid stripping elements (510, 610, 710, 810, 910, 960 and 980) has a diameter of around 4 mm, which is also indicated by the symbol “40”. This means that each opening, which each of the plurality of rigid stripping elements protrudes from, on the top surface of the base structure of a marine growth removal device also has a diameter of around 4 mm.

FIG. 10 is a perspective view of two of the marine growth removal devices 100 of FIG. 1A engaging with each other. Reference numerals 100a and 100b are used to denote the two marine growth removal devices. Joining two marine growth removal devices 100a and 100b as seen in FIG. 10 forms a brush-cart. With a suitable large brush-cart made up of several marine growth removal devices (such as 6 devices) is used, cleaning rates of up to, for example, 15 m²/min (a 5 m by 3 m area) can be expected. Such a brush-cart may be directionally powered using a propulsion device such as a water-jet or connected to mechanical/hydraulic/electrical powered wheels or tracks.

It can be observed that the protrusion 122, provided along a perimeter of the base structure 106 of the marine growth removal device 100a, couples to the notch 124 provided along a perimeter of the base structure 106 of the marine growth removal device 100b. More marine growth removal devices can be coupled together (although not shown) in a similar manner, so that the rigid stripping elements 110 can cover a larger area and reduce the amount of time needed to strip marine growth from a surface such as a ship hull or oil rig platforms. In addition, one of the plurality of the rigid stripping elements 110 is located in the vicinity of the protrusion 122 to ensure that marine growth removal also occurs at the area where the marine growth removal devices 100a and 100b couple.

In the case where only one of the marine growth removal devices is mounted to a drive motor, operating several of the marine growth removal devices together provides the additional advantage of distributing torque evenly to each marine growth removal device. By reducing the torque, it becomes easier to operate, especially underwater, a device incorporating several of the marine growth removal devices.

The rigid stripping elements 110 are located, in symmetrically spaced groups 1002 with respect to the base structure 106. In the embodiment shown in FIG. 10, there are six symmetrically spaced groups 1002 on the top surface 106t of the base structure 106. The base structure 106 has an individual opening 120 for each of the plurality of the rigid stripping elements 110.

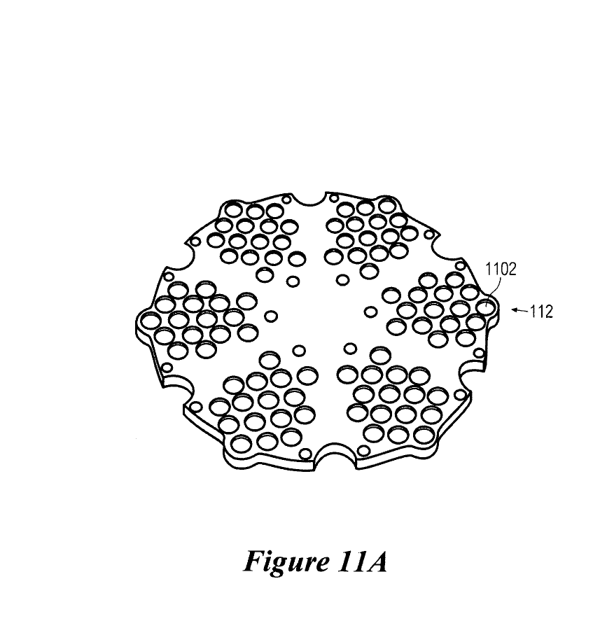

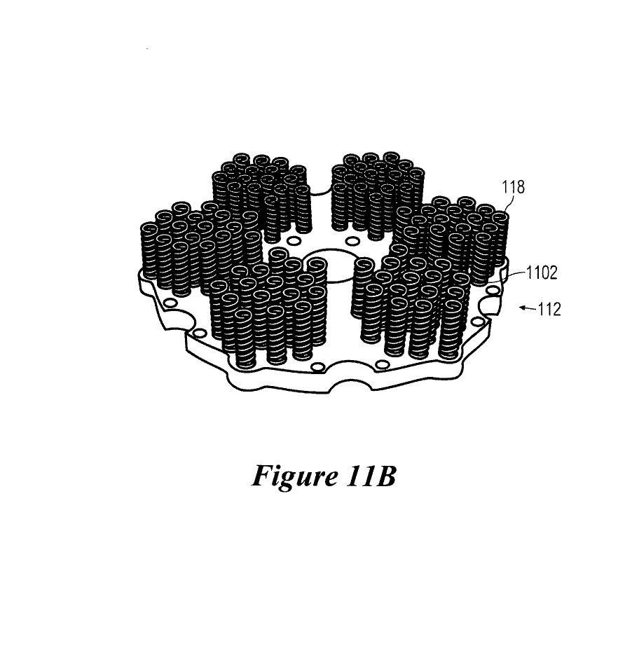

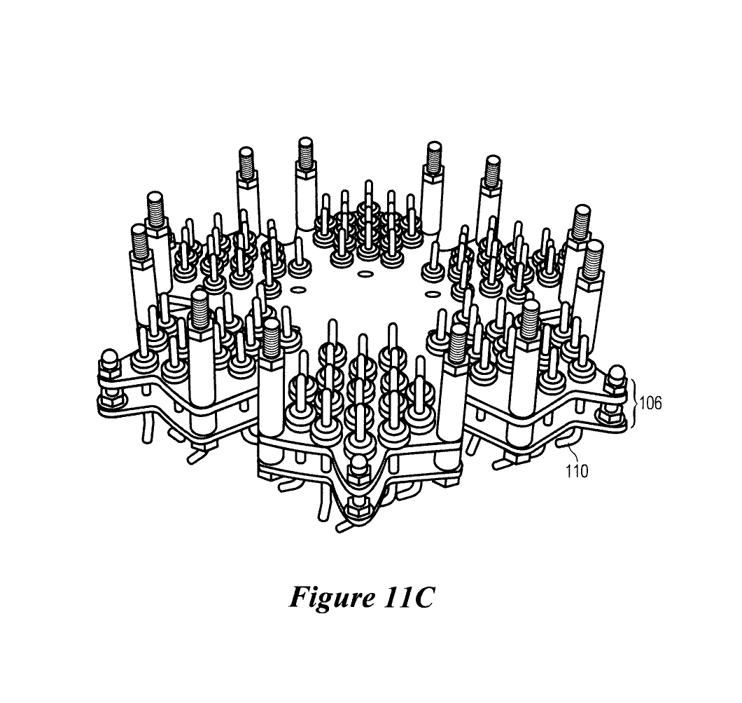

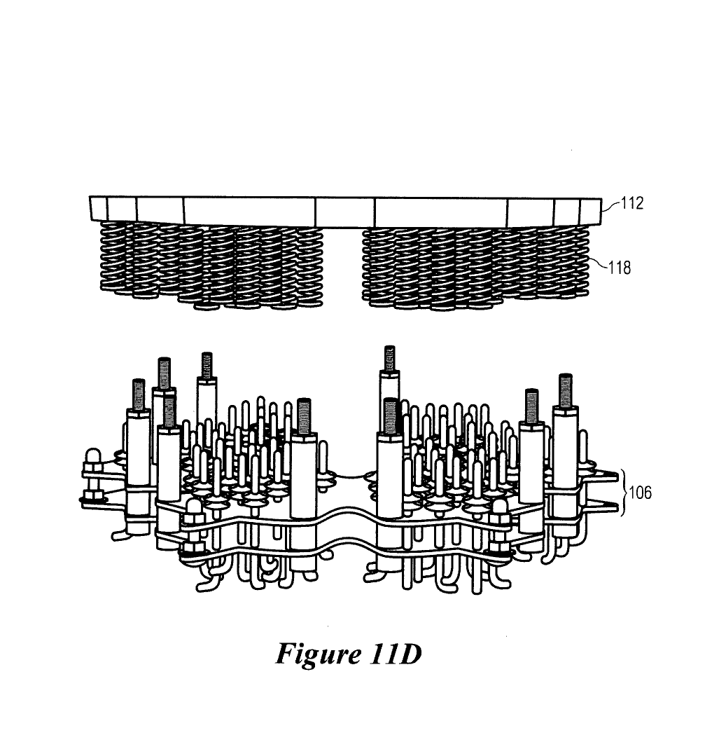

FIGS. 11A to 11D are perspective views of individual components of the marine growth removal device 100 of FIG. 1.

FIG. 11A is a perspective view of the mounting plate 112. The mounting plate has a plurality of recesses 1102, where each recess 1102 serves to accommodate a respective biasing element 118 (see FIG. 11B). Each recess 1102 has a certain depth to adequately secure the respective biasing element 118.

FIG. 11B is a perspective view of the mounting plate 112 with a respective biasing element 118 introduced into each of the plurality of recesses 1102.

The mounting plate has a plurality of recesses 1102, where each recess 1102 serves to accommodate a respective biasing element 118.

FIG. 11C is a perspective view of the base structure 106. The plurality of rigid stripping elements 110 has already been mounted to the base structure 106.

FIG. 11D is a perspective view of the mounting plate 112 prior to being coupled to the base structure 106. During mounting, each of the plurality of rigid stripping elements 110 will be aligned with a respective biasing element 118.

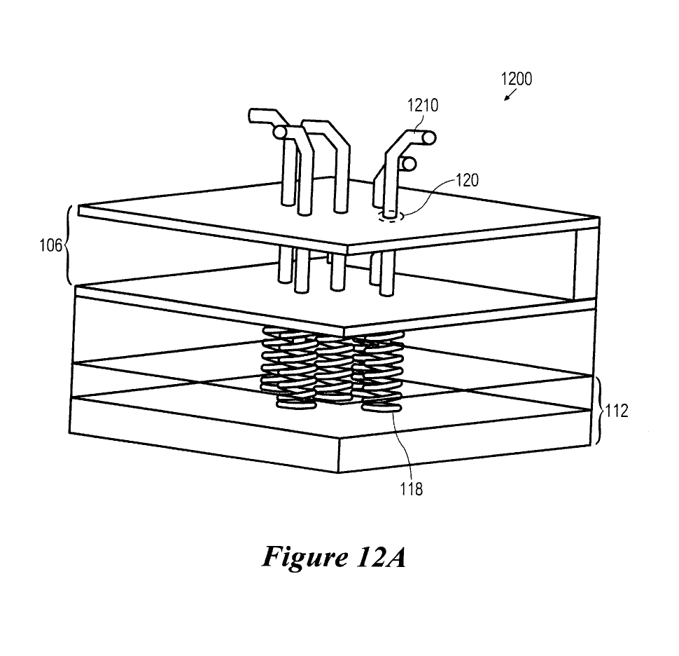

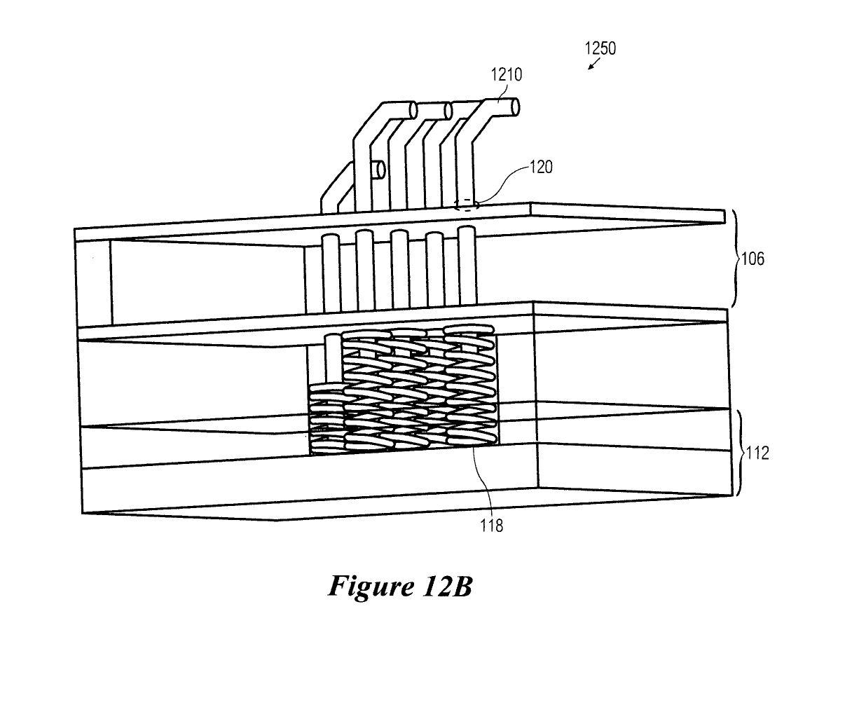

FIGS. 12A and 12B show different cross-sectional views 1200 and 1250 of portions of a marine growth removal device according to another embodiment of the present invention. FIGS. 12A and 12B further illustrate the rotational nature of rigid stripping elements 1210 at the opening 120 provided on the base structure 106.

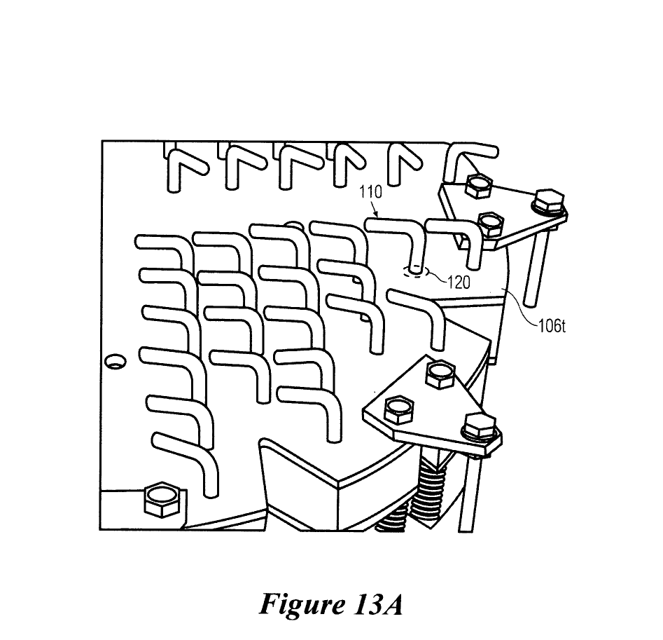

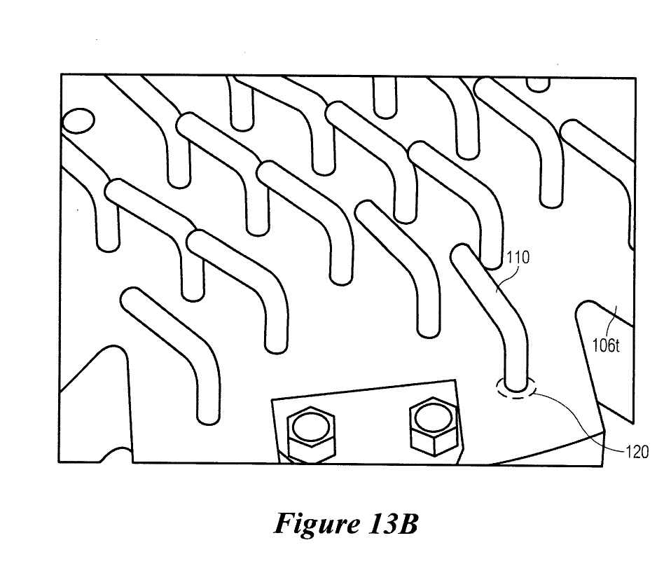

FIGS. 13A and 13B are close-up views of the marine growth removal device 150 of FIG. 1B. Each stripping element 110 can be seen to protrude from a respective opening 120 on the top surface 106t of the base structure 106.

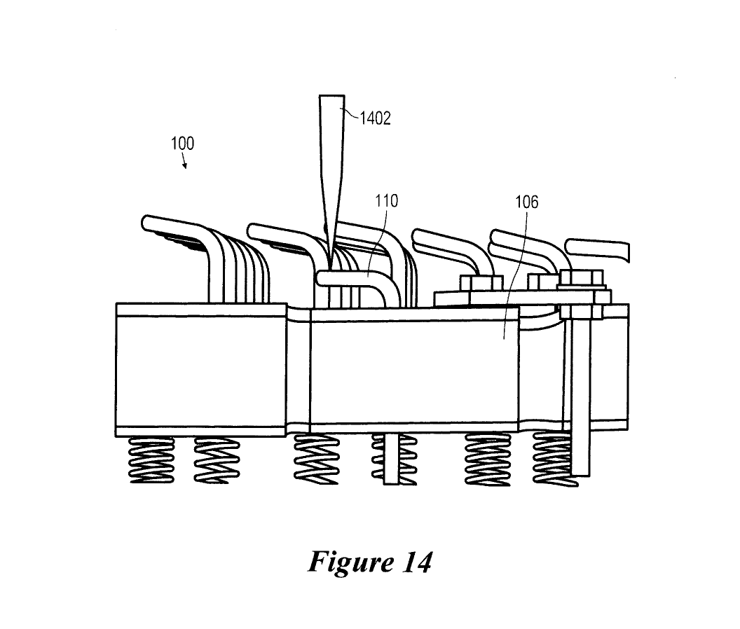

FIG. 14 shows the stripping element 110 being depressed into the base structure 106 when the stripping element encounters a protrusion 1402 (such as a rivet or weld) on a surface upon which the marine growth removal device 150 is applied.

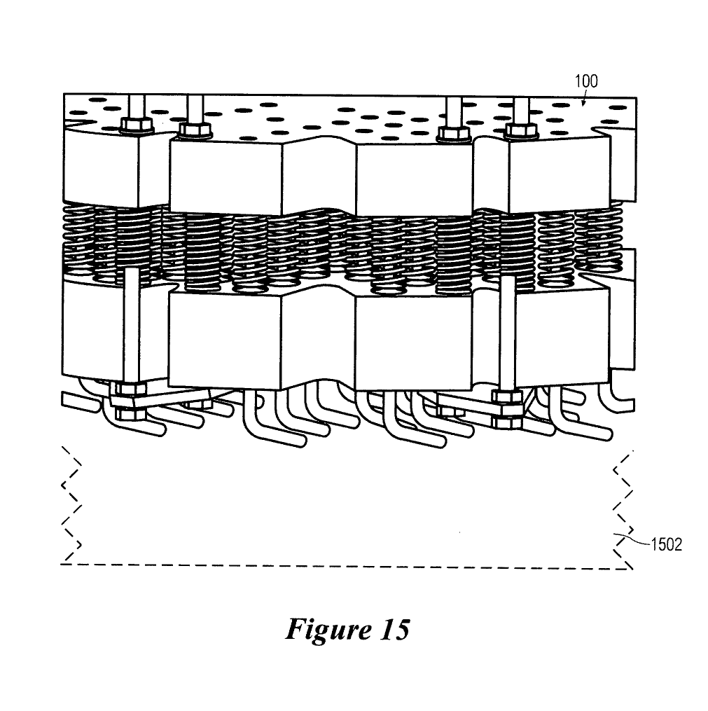

FIG. 15 shows the marine growth removal device 100 being applied onto a planar surface 1502.

The following materials can be used for the various features of the marine growth removal device shown in its different embodiments in the Figures. The plurality of rigid stripping elements (110, 210, 310, 410, 510, 610, 710, 810, 910, 960, 980, 1110 and 1210) may be formed from metallic material, a metal, an alloy, ceramic, plastic or stainless steel. It will be appreciated that other materials are possible, such as copper and brass. The base structure (106 and 1106) and the mounting plate (112) are shown to be disc-shaped. The top surface (106t and 1106t) of the base structure (106 and 1106) may be a surface of a first panel, the first panel formed from materials such as stainless steel, copper, brass, plastics, ceramics or non-metallic laminates. The bottom surface (106b) of the mounting plate (112) may be a surface of a second panel, the second panel formed from materials such as stainless steel, copper, brass, plastics, ceramics or non-metallic laminates. As shown in FIG. 1A, the first plate 180 and the second plate 182 are separated by the spacer 108, which may be made of wood, plastics, ceramics or non-metallic laminates. The support members 116 may be made of wood, plastics, ceramics or non-metallic laminates. For these non-metallic laminates mentioned above, they may be reinforced resins comprising layers of material such as cotton cloth, paper or woven glass cloth. An example of a non-metallic laminate is a Tufnol™ laminate. It will be appreciated that the plastics mentioned above are of a resilient nature which do not break easily. When manufacturing, for example, the mounting plate 112 and the base structure (106 and 1106) using plastic, a plastic injection molding process may be employed.

The following paragraphs provide uses for the marine growth removal device shown in its different embodiments in the Figures.

### Vessels Due for Drydock

Gross marine growth removal may take place prior to entry of a vessel into drydock. Pre-cleaning the hull before entering the drydock can save, for example, 24 hours worth of dock time and fees. Additional charges for the disposal of marine growth debris will no longer apply. Heavily fouled vessels, for example, can shed 30-40 kg/m².

### Barge Operators

This includes flat-top, pipe-lay, heavy lift barges, FSPOs (Floating Storage Production Offloading), semisub rigs and platforms. The removal of heavy marine growth results in savings in towage time and/or fuel costs.

### Subsea Inspection Providers

Savings come in the form of both time and manpower spent on marine growth removal especially on such contracts as UWILD (Underwater Inspection In Lieu of Docking) seam inspections, impact damage surveys, video/still photographic surveys and deformation metrology reports.

### Diving Services Companies

An inexpensive, diver-friendly method of cleaning that equals savings in both time and manpower on any contract that requires marine growth removal.

1. A marine growth removal device, adapted to be mounted to a drive motor which allows the marine growth removal device to be rotatable about an axis, the marine growth removal device comprising:
a base structure having a top surface; and
a plurality of rigid stripping elements rotatably mounted to the base structure, wherein a stripping portion of the plurality of rigid stripping elements passes through the base structure to extend from the top surface of the base structure.

2. The marine growth removal device of claim 1, wherein at least one of the plurality of the rigid stripping elements is able to translate through the base structure to vary the height to which the at least one of the rigid stripping elements extends from the top surface of the base structure.

3. The marine growth removal device of claim 1, further comprising a biasing element able to engage with a respective rigid stripping element to have each rigid stripping element biased to extend from the top surface of the base structure.

4. The marine growth removal device of claim 1, further comprising a mounting plate coupled to a bottom surface of the base structure, the bottom surface being opposite to the top surface of the base structure.

5. The marine growth removal device of claim 4, wherein the biasing element is disposed between the mounting plate and the base structure.

6. The marine growth removal device of claim 4, wherein the biasing element is disposed within the mounting plate.

7. The marine growth removal device of claim 3, wherein the biasing element is a spring or a deformable material.

8. The marine growth removal device of claim 1, wherein the stripping portion of the plurality of the rigid stripping elements comprises any one or more of the following structures: an “L” shaped bend; an arc shaped bend; a curved shaped bend; a single or multiple pointed end; a nut and a cylindrical protrusion.

9. The marine growth removal device of claim 1, wherein at least one of the plurality of the rigid stripping elements comprises a restraining washer capable of engaging a bottom surface of the base structure, the bottom surface opposite to the top surface of the base structure.

10. The marine growth removal device of claim 1, wherein the plurality of the rigid stripping elements is arranged in symmetrically spaced groups with respect to the base structure.

11. The marine growth removal device of claim 1, wherein the base structure has an individual opening for each of the plurality of the rigid stripping elements.

12. The marine growth removal device of claim 1, wherein the base structure comprises a first plate; a second plate and a spacer to distance the first plate from the second plate.

13. The marine growth removal device of claim 4, wherein the mounting plate is provided with a motor shaft receptacle for mounting to a drive motor, the motor shaft receptacle being provided on a surface opposite to the surface the mounting plate is coupled to the base structure.

14. The marine growth removal device of any claim 1, wherein the plurality of rigid stripping elements are formed from a metal or an alloy thereof, ceramic or plastic.

15. The marine growth removal device of claim 1, wherein the base structure is disc shaped and further comprises at least one protrusion formed along a perimeter of the base structure, the at least one protrusion planar with the base structure and the at least one protrusion shaped to correspond to a notch formed along the perimeter of the base structure.
